(19) United States
(12) Patent Application Publication
(10) Pub. No.: US 2009/0127317 A1
(43) Pub. Date: May 21, 2009

(54) DEVICE AND METHOD FOR PRODUCING A BONDING CONNECTION

(75) Inventors: Dirk Siepe, Warstein (DE); Guido Strotmann, Anroechte (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Infineon Technologies AG, Neubiberg (DE)

(21) Appl. No.: 11/940,686

(22) Filed: Nov. 15, 2007

(51) Int. Cl. B23K 20/10

(52) U.S. Cl. 228/110.1; 228/1.1

(57) ABSTRACT

A bonding device and method for producing a bonding connection is disclosed. One embodiment provides a bonding stamp and an ultrasonic generator coupled thereto. The ultrasonic frequency and an effective length, which is given by the distance between the lower end of the bonding stamp and the coupling location of the ultrasonic generator at the bonding stamp in the vertical direction, are coordinated with one another in such a way that the following holds true:

$$0.9 \cdot n \cdot \frac{c}{2 \cdot l} \leq f \leq 1.1 \cdot n \cdot \frac{c}{2 \cdot l}$$

where c is the speed of the ultrasound in the bonding stamp at the frequency f, and n=1 or 2 or 3 or 4.

### BACKGROUND

The invention relates to a bonding device and a method for producing a bonding connection.

Bonding connections are used in many areas of electronics for the production of electrically conductive connections. Wires composed of aluminum or based on aluminum are usually used in this case. On account of the increasing miniaturization of electronic components and increased junction temperatures in power semiconductor chips, the bonding wires used have to carry more and more current since a parallel connection of a plurality of bonding wires, if possible at all, is limited owing to the increasing miniaturization of the components. Instead of using an aluminum wire for producing a contact, it is desirable, in order to reduce the power loss occurring during the operation of the power semiconductor module, to use as conducting material pure copper or a copper-based alloy having a high proportion of copper. Copper has a thermal conductivity of 388 W/(m·K) and an electrical resistivity of 0.0172 ohm·mm²/m. Aluminum has a thermal conductivity of 226 W/(m·K) and an electrical resistivity of 0.028 ohm·mm²/m. By using copper instead of aluminum, the thermal and electrical resistance can be almost halved with otherwise identical bonding wire geometry. In addition, copper-based bonding wires have a higher mechanical stiffness and a higher modulus of elasticity than aluminum-based bonding wires, that is to say that they are in the elastic range for longer, which, in the case of intensive thermal cycling operation, is tantamount to a longer service life. At the present time, however, there are neither machines nor methods for bonding bonding wires composed of copper or based on copper with diameters of more than 100 μm using ultrasound reliably and reproducibly by using a wedge-wedge method. This applies to copper-based bonding wires having higher diameters, for example having diameters of greater than or equal to 400 μm or having cross-sectional areas of greater than or equal to 0.125 mm². A copper wire having a diameter of 400 μm can thus replace an aluminum wire having a diameter of approximately 500 μm without increasing the electrical resistance. Therefore, there is a need for a bonding device which is suitable for bonding copper-based bonding wires. Likewise, there is a need for a method which is suitable for producing bonding connections with copper-based bonding wires.

For these and other reasons, there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1A illustrates a side view of a bonding device according to the invention with a bonding stamp, to the upper end of which an ultrasonic generator is coupled, which couples ultrasound of a predetermined frequency into the bonding stamp.

FIG. 1B illustrates a schematic illustration of the zeroth oscillation mode of the bonding stamp in accordance with FIG. 1A.

FIG. 1C illustrates a schematic illustration of the first oscillation mode of the bonding stamp in accordance with FIG. 1A.

FIG. 1D illustrates a schematic illustration of the second oscillation mode of the bonding stamp in accordance with FIG. 1A.

FIG. 1E illustrates a schematic illustration of the third oscillation mode of the bonding stamp in accordance with FIG. 1A.

FIG. 2A illustrates the bonding device in accordance with FIG. 1A in the production of a bonding connection during a production process in which a bonding wire guided by the bonding device is led together with the bonding device to the metallization of a substrate.

FIG. 2B illustrates a vertical section through the arrangement in accordance with FIG. 2A in a sectional plane A-A′, which reveals that the bonding wire is guided at the lower end of the bonding stamp in a cross-sectionally concave, for example u-shaped, guide groove.

FIG. 2C illustrates a cross section corresponding to FIG. 2B, in which, however, a cross-sectionally v-shaped guide groove is provided instead of a cross-sectionally u-shaped guide groove for guiding the bonding wire.

FIG. 3A illustrates the arrangement in accordance with FIG. 2A at the moment when the bonding wire is placed onto the metallization.

FIG. 3B illustrates a vertical section through the arrangement in accordance with FIG. 3A, in a sectional plane A-A′ in the case of a bonding stamp having a cross-sectionally u-shaped guide groove.

FIG. 3C illustrates a vertical section through the arrangement in accordance with FIG. 3A, in a sectional plane A-A′ in the case of a bonding stamp having a cross-sectionally v-shaped guide groove.

FIG. 4A illustrates the arrangement in accordance with FIGS. 2A and 3A, wherein an ultrasound having a predetermined frequency is coupled into the bonding stamp by using the ultrasonic generator and the bonding wire is simultaneously pressed onto the metallization by using a predetermined force.

FIG. 4B illustrates a vertical section through the arrangement in accordance with FIG. 4A, in a sectional plane A-A′ in the case of a bonding stamp having a cross-sectionally u-shaped guide groove.

FIG. 4C illustrates a vertical section through the arrangement in accordance with FIG. 4A, in a sectional plane A-A′ in the case of a bonding stamp having a cross-sectionally v-shaped guide groove.

FIG. 5A illustrates the arrangement in accordance with FIGS. 2A, 3A and 4A in which the bonding wire is separated after the production of the bonding connection using a cutting device.

FIG. 5B illustrates a vertical section through the arrangement in accordance with FIG. 5A, in a sectional plane A-A′ in the case of a bonding stamp having a cross-sectionally u-shaped guide groove.

FIG. 5C illustrates a vertical section through the arrangement in accordance with FIG. 5A, in a sectional plane A-A′ in the case of a bonding stamp having a cross-sectionally v-shaped guide groove.

FIG. 6A illustrates the arrangement in accordance with FIGS. 2A, 3A, 4A and 5A after the severing of the bonding wire, wherein the bonding stamp is moved away from the bonding wire bonded onto the metallization and away from the metallization, and wherein ultrasound is fed into the bonding stamp in order to have the effect that the bonding stamp disengages more readily from the bonding wire.

FIG. 6B illustrates a vertical section through the arrangement in accordance with FIG. 6A, in a sectional plane A-A′ in the case of a bonding stamp having a cross-sectionally u-shaped guide groove.

FIG. 6C illustrates a vertical section through the arrangement in accordance with FIG. 6A, in a sectional plane A-A′ in the case of a bonding stamp having a cross-sectionally v-shaped guide groove.

FIG. 7A illustrates the arrangement in accordance with FIGS. 2A, 3A, 4A, 5A and 6A after the detachment of the bonding stamp from the bonding wire.

FIG. 7B illustrates a vertical section through the arrangement in accordance with FIG. 7A, in a sectional plane A-A′ in the case of a bonding stamp having a cross-sectionally u-shaped guide groove.

FIG. 7C illustrates a vertical section through the arrangement in accordance with FIG. 7A, in a sectional plane A-A′ in the case of a bonding stamp having a cross-sectionally v-shaped guide groove.

FIG. 8A illustrates an enlarged view of the lower end of the bonding stamp in accordance with FIG. 1A with a cross-sectionally u-shaped guide groove.

FIG. 8B illustrates an enlarged view of the lower end of a bonding stamp constructed according to the bonding stamp in accordance with FIG. 1A, but having a cross-sectionally v-shaped guide groove instead of a u-shaped guide groove.

FIG. 9A illustrates a surface portion of a guide groove in accordance with FIG. 8A or 8B with an engaging structure formed in waffle-type fashion, in plan view.

FIG. 9B illustrates a cross section through the surface portion in accordance with FIG. 9A in a sectional plane B-B′.

FIG. 10A illustrates a surface portion of a guide groove in accordance with FIG. 8A or 8B in which the engaging structure includes transverse grooves running transversely with respect to the guide groove, in plan view.

FIG. 10B illustrates a cross section through the surface portion in accordance with FIG. 10A in a sectional plane C-C′.

FIG. 11A illustrates a surface portion of a guide groove in accordance with FIG. 8A or 8B, wherein the surface is roughened and has a predetermined surface roughness, in plan view.

FIG. 11B illustrates a cross section through the surface portion in accordance with FIG. 11A in a sectional plane D-D′.

FIG. 12A illustrates a surface portion of a guide groove in accordance with FIG. 8A or 8B, wherein a granular structure is applied to the bonding stamp in the region of the surface portion, in plan view.

FIG. 12B illustrates a cross section through the surface portion in accordance with FIG. 12A in a sectional plane E-E′.

FIG. 13A illustrates a vertical section through the lower portion of a bonding stamp having a guide groove which is provided at its top side with transverse grooves which run transversely with respect to the guide groove and which run perpendicular to the vertical direction, through an elevated portion of the transverse grooves.

FIG. 13B illustrates a vertical section through the arrangement in accordance with FIG. 13A in a sectional plane parallel to the plane of the illustration in accordance with FIG. 13A, through a recessed portion of the transverse groove.

FIG. 13C illustrates a plan view of the transverse groove structure in accordance with FIGS. 13A and 13B counter to the vertical direction.

FIG. 13D illustrates a cross section through the arrangement in accordance with FIG. 13C in a sectional plane H-H′.

FIG. 14A illustrates a portion of a bonding wire having a circular cross section such as was used by way of example in the method explained with reference to FIGS. 2A to 7C.

FIG. 14B illustrates a bonding wire which is formed as a flat ribbon and which may have the same material compositions as the bonding wire in accordance with FIG. 14A, but which includes a non-circular cross section.

FIG. 15A illustrates a perspective view of a guide device of a bonding device which is formed from metal or ceramic and into which a bonding wire in accordance with FIG. 14A is inserted.

FIG. 15B illustrates a perspective view of a guide device of a bonding device which is formed from metal or ceramic and into which a bonding line in accordance with FIG. 14B is inserted.

FIG. 16A illustrates a cross section through the guide device in accordance with FIG. 15A in a sectional plane I-I′.

FIG. 16B illustrates a cross section through the guide device in accordance with FIG. 15B in a sectional plane J-J′.

FIG. 17A illustrates a perspective view of a guide device of a bonding device which includes, in the guide region on its side facing an inserted bonding wire in accordance with FIG. 14A, a surface region formed from metal or from ceramic.

FIG. 17B illustrates a perspective view of a guide device of a bonding device which includes, in the guide region on its side facing an inserted ribbon in accordance with FIG. 14B, a surface region formed from metal or from ceramic.

FIG. 18A illustrates a cross section through the guide device in accordance with FIG. 17A in a sectional plane K-K′. and

FIG. 18B illustrates a cross section through the guide device in accordance with FIG. 17B in a sectional plane L-L′.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various example embodiments described herein may be combined with each other, unless specifically noted otherwise.

One embodiment provides a device including a bonding stamp and an ultrasonic generator. The bonding stamp has an upper end and a lower end, which are spaced apart from one another in a vertical direction. The ultrasonic generator is designed to generate ultrasound of at least one predetermined frequency f and is coupled or can be coupled acoustically to the bonding stamp at a coupling location of the bonding stamp in the region of the upper end. The frequency f and an effective length l, which is given by the distance between the coupling location and the lower end in the vertical direction, are coordinated with one another in such a way that the following holds true:

$$0.9 \cdot n \cdot \frac{c}{2 \cdot l} \leq f \leq 1.1 \cdot n \cdot \frac{c}{2 \cdot l}$$

where c is the speed of the ultrasound in the bonding stamp at the predetermined frequency f, and n=1 or 2 or 3 or 4. This means that the frequency f differs by no more than 10% from the frequency of the zeroth mode (n=1), the first mode (n=2) or the second mode (n=3) or the third mode (n=4).

A further embodiment is directed at a method for producing a bonding connection between a first bonding partner and a second bonding partner. The method includes:

(a) providing a bonding device including a bonding stamp having an upper end and a lower end and providing an ultrasonic generator, which is designed to generate ultrasound of at least one predetermined frequency f and which is coupled or can be coupled acoustically to the bonding stamp to a coupling location situated in the region of the upper end of the bonding stamp, wherein the frequency f and an effective length l, which is given by the distance between the coupling location and the lower end in the vertical direction, are coordinated with one another in such a way that the following holds true:

$$0.9 \cdot n \cdot \frac{c}{2 \cdot l} \leq f \leq 1.1 \cdot n \cdot \frac{c}{2 \cdot l}$$

where c is the speed of the ultrasound in the bonding stamp at the frequency f, and n=1 or 2 or 3 or 4;

(b) providing a first bonding partner and a second bonding partner;

(c) arranging the second bonding partner between the first bonding partner and the bonding stamp;

(d) generating ultrasound of the frequency f by using the ultrasonic generator and coupling the ultrasound into the bonding stamp in the region of the upper end whilst simultaneously pressing the second bonding partner onto the first bonding partner by using the bonding stamp.

Yet another embodiment relates to a method for producing a bonding connection between a first bonding partner and a second bonding partner. This involves providing a bonding device having a bonding stamp and an ultrasonic generator, which is designed to generate ultrasound of at least one predetermined frequency f, and also a first and a second bonding partner. After arranging the second bonding partner between the first bonding partner and the bonding stamp, ultrasound of the frequency f is generated by using the ultrasonic generator and coupled into the bonding stamp whilst the second bonding partner is simultaneously being pressed onto the first bonding partner by using the bonding stamp. The process of coupling in ultrasound at the same time as pressing the second bonding partner onto the first bonding partner is ended depending on the ultrasonic energy emitted by the bonding stamp.

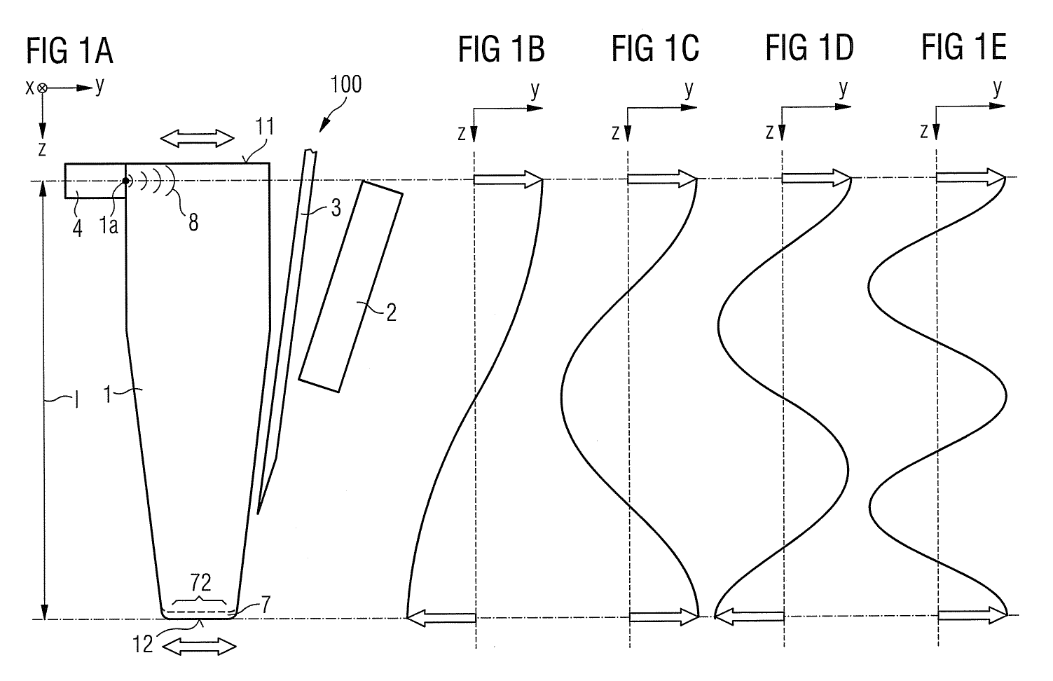

FIG. 1A illustrates a side view of a device 100. The device includes a bonding stamp 1, a guide device 2 for guiding a bonding wire, an optional cutting device 3 for at least partly separating a bonding wire, and also an ultrasonic generator 4 for generating ultrasound of a predetermined frequency f. The bonding stamp 1 has an effective length l in a vertical direction z between a coupling location 1a of the bonding stamp 1 and a lower end 12 of the bonding stamp 1. The coupling location 1a may be provided for example by the area centroid of the surface portion of the bonding stamp via which the ultrasonic generator for coupling an ultrasonic wave into the bonding stamp 1 is coupled or can be coupled to the bonding stamp. A bonding wire (not illustrated in FIG. 1A) may be inserted into a bonding wire reservoir (likewise not illustrated) and proceeding from the latter, may be guided via the guide device 2 by using a guide groove 7, which is arranged at the lower end 12 of the bonding stamp 1 and the upper end of which is illustrated in dashed fashion. The guide groove 7 may optionally include a horizontal portion 72 running in a first lateral direction y perpendicular to the vertical direction z.

The ultrasonic generator 4 is coupled or can be coupled acoustically to the bonding stamp 1 in the region of the upper end 11, such that an ultrasound 8 generated by the ultrasonic generator 4 is coupled into the bonding stamp 1 in the region of the upper end 11. The coupling may be effected in such a way that the ultrasound 8 causes the upper end 11 of the bonding stamp 1 to effect horizontal oscillations in the first lateral direction y.

The effective length l of the bonding stamp 1 and the frequency f of the ultrasonic wave 8 are coordinated with one another in such a way that the following holds true:

$$0.9 \cdot n \cdot \frac{c}{2 \cdot l} \leq f \leq 1.1 \cdot n \cdot \frac{c}{2 \cdot l}$$

where c is the speed of the ultrasound in the bonding stamp at the frequency f, and n=1 or n=2 or n=3 or n=4. This ensures that the bonding stamp 1 oscillates within the bounds of a 10 percent deviation with the frequency of the zeroth mode (n=1), the first mode (n=2) or the second mode (n=3) or the third mode (n=4). In comparison with conventional bonding stamps, which typically oscillate in the 6-th or 7-th mode, this results in a significantly stronger oscillation—which therefore cannot be damped as readily—of the lower end 12 of the bonding stamp 1.

As an alternative to this, the permissible range of the frequency f may also be chosen such that the following holds true:

$$0.95 \cdot n \cdot \frac{c}{2 \cdot l} \leq f \leq 1.05 \cdot n \cdot \frac{c}{2 \cdot l}$$

This corresponds to a maximum 5% deviation of the frequency f from the frequency of the zeroth mode (n=1), the first mode (n=2) or the second mode (n=3) or the third mode (n=4).

FIG. 1B illustrates by way of example the amplitude of the bonding stamp 1 oscillating in the zeroth mode. It holds true here that the effective length l of the bonding stamp 1 is chosen to be equal to half the wavelength of the ultrasonic signal 8. The following relationship holds true:

$$f = 1 \cdot \frac{c}{2 \cdot l} .$$

As can be seen from FIG. 1B, here the upper end 11 and the lower end 12 oscillate in opposite phases with a phase shift of 180°.

FIG. 1C correspondingly illustrates the first oscillation mode, for which the following holds true:

$$f = 2 \cdot \frac{c}{2 \cdot l} .$$

In this case, the effective length l of the ultrasonic generator 4 is identical to the wavelength of the ultrasonic wave 8. The upper end 11 and the lower end 12 oscillate in phase.

FIG. 1D correspondingly illustrates the second oscillation mode, for which the following relationship holds true:

$$f = 3 \cdot \frac{c}{2 \cdot l}$$

The upper end 11 and the lower end 12 once again oscillate in antiphase.

Furthermore, FIG. 1E illustrates the third oscillation mode, for which the following relationship holds true:

$$f = 4 \cdot \frac{c}{2 \cdot l}$$

The upper end 11 and the lower end 12 once again oscillate in phase.

In order to produce specific bonding connections to which access is difficult to gain, for example if the bonding connections have to be produced in a semiconductor module already surrounded by a frame, it may be necessary for the effective length l of the bonding stamp 1 to have a specific minimum length. In order to attain this, given a predetermined ultrasonic frequency f and a predetermined oscillation mode of the bonding stamp 1, it may be advantageous to use a material with high sound speed for the bonding stamp 1. In one embodiment, it is possible to choose a material in which the sound speed is higher than 10 000 m/s and thus significantly higher than the sound speed of approximately 8350 m/s in the tungsten carbide used for producing conventional bonding stamps. By way of example, silicon carbide, which has a sound speed of approximately 13 000 m/s, may be chosen as material for the bonding stamp 1. Nevertheless the invention may also be used in conjunction with a bonding stamp 1 composed of tungsten carbide.

The bonding stamp 1 may have for example an effective length l of greater than or equal to 6.35 cm (2.5″), or of greater than or equal to 8.9 cm (3.5″). In principle, an effective length shorter or longer than those mentioned may also be provided for a bonding stamp 1. Any desired ultrasonic frequencies, for example 20 kHz, 40 kHz, 60 kHz, 80 kHz or 90 kHz, are suitable as ultrasonic frequencies f. In order to have the effect that a bonding stamp 1 may be operated such that it may be changed over in the zero-th, first, second or third oscillation mode, the ultrasonic generator may be designed to provide at least two, for example four, frequencies f1, f2, f3, f4 having a ratio f1:f2:f3:f4 of 4:3:2:1. The at least two frequencies f1, f2, f3, f4 may deviate from the computational values of the exact resonant frequencies of the bonding stamp 1 by up to ±10% in each case, for example in order to avoid component resonances of the components to be bonded and of components coupled or connected thereto.

Moreover, the ultrasonic generator 4 may be designed to alter the frequency of the ultrasonic signal 8 during the bonding operation at the same bonding location and/or to provide ultrasonic signals having different frequencies for the bonding of bonding locations that are to be successively bonded (“bonding sequence”). This affords the advantage that an individual adaptation of the bonding operation to different bonding locations becomes possible. It is thus possible for example to avoid resonances of the bonding partners involved and/or to optimize the inputting of ultrasonic energy into the respective bonding location. In order to avoid resonances or oscillations close to resonance, the frequency of an ultrasonic signal used for bonding may be spaced apart by at least 5 kHz from the resonant frequency or resonant frequencies which can occur at the components to be bonded or connected thereto.

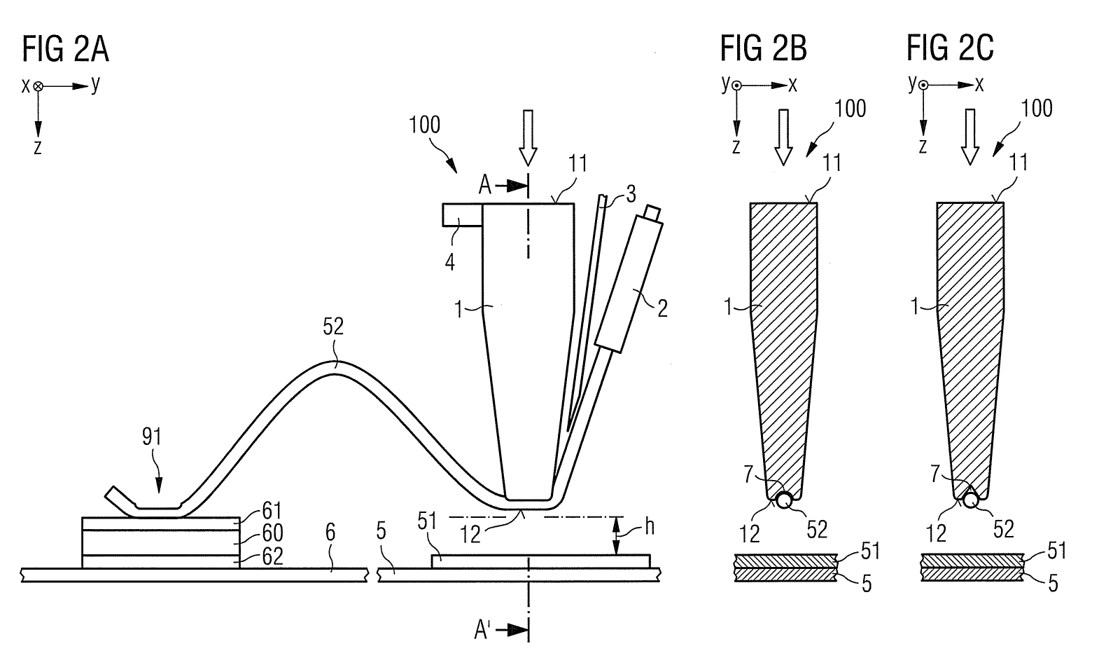

Various processes of a method for producing a bonding connection between a copper-based bonding wire and a metallization of a substrate using the bonding device 100 explained in FIG. 1A are explained in more detail below with reference to FIGS. 2A to 7C. FIG. 2A illustrates in side view a substrate 5 with a metallization 51, and also a substrate 6, to which is applied a semiconductor chip 60 with a top-side metallization 61 and a bottom-side metallization 62. At a first bonding location 91, a copper-based bonding wire 52 is bonded onto the top-side metallization 61 arranged on that side of the semiconductor chip 60 which is remote from the substrate 6. Copper-based bonding wire is understood to mean a bonding wire which includes copper or includes a specific minimum proportion of copper, for example 99% by weight.

In order to electrically conductively connect the metallization 61 to the metallization 51, the copper based bonding wire 52 is also intended to be bonded onto the metallization 51. Proceeding from the first bonding location 91, the bonding wire 52 forms a loop resulting from the fact that the bonding device 100, after the production of the first bonding location 91, was moved upward, i.e. counter to the vertical direction z, and also in the first lateral direction y into a position above the metallization 51 and was subsequently lowered again downward, i.e. in the vertical direction z, toward the metallization 51. The bonding wire 52 is guided by using the guide device 2 and also by using a guide groove (not discernible in FIG. 2A), which is arranged at the lower end 12 of the bonding stamp 1 and which runs in a plane spanned by the vertical direction z and the first lateral direction y.

FIG. 2B illustrates a vertical section through the arrangement in accordance with FIG. 2A in a sectional plane A-A′ perpendicular to the first lateral direction y. The guide groove 7 is discernible in this view, the guide groove having a u-shaped cross section in this exemplary embodiment. In principle, such guide grooves 7 may have other cross sections. Thus, FIG. 2C, which for the rest corresponds to the sectional view in accordance with FIG. 2B, illustrates by way of example a guide groove 7 having a v-shaped cross section.

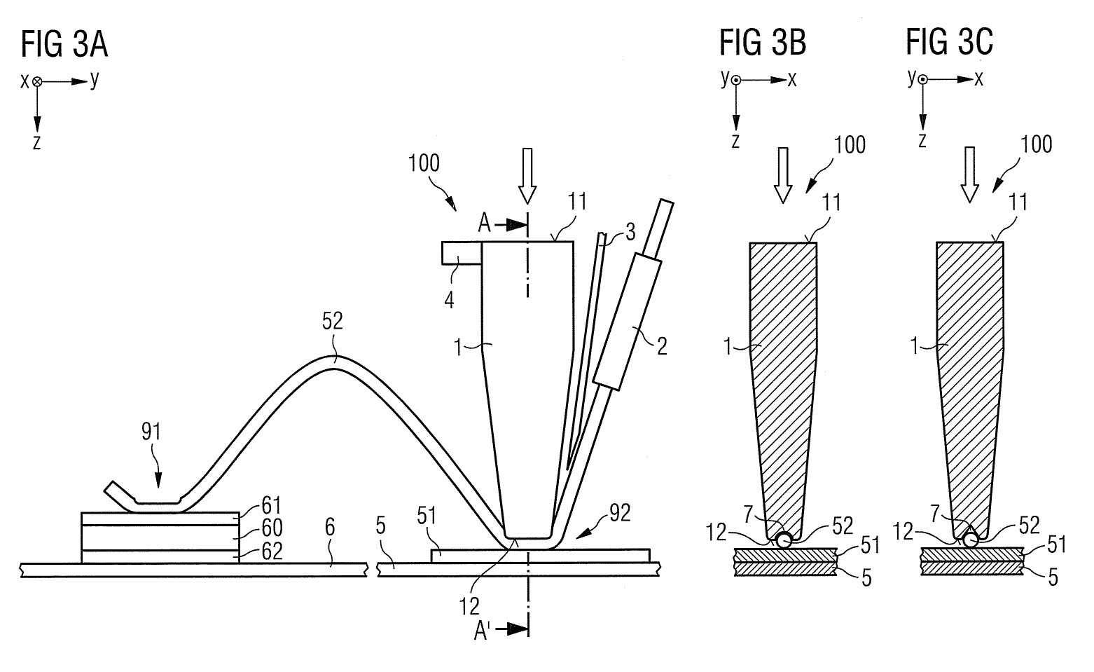

If the bonding device 100, proceeding from the arrangement in accordance with FIGS. 2A to 2C, is moved together with the bonding wire 52 in the vertical direction z toward the metallization 51, then the lower end 12 of the bonding stamp 1 at some time reaches a predetermined search height h above the metallization 51, which may be for example 50 μm to 1000 μm. The term “touch down area” is also used sometimes instead of the term “search height”. The area is the region between the search height and the bonding partner, that is to say here the metallization 51. Upon reaching or undershooting the predetermined search height h, the speed at which the bonding stamp 1 is moved toward the metallization 51 may be reduced in order to avoid damage to the metallization 51 and the bonding stamp 1. If the bonding device 100 is moved further toward the metallization 51, then at some time contact occurs between the bonding wire 52 and the metallization 51. This state is also referred to as “touchdown” and is represented in FIG. 3A. FIGS. 3B and 3C illustrates the arrangement in accordance with FIG. 3A in the sectional plane A-A′ for a bonding stamp having a cross-sectionally u-shaped and, respectively, v-shaped guide groove 7.

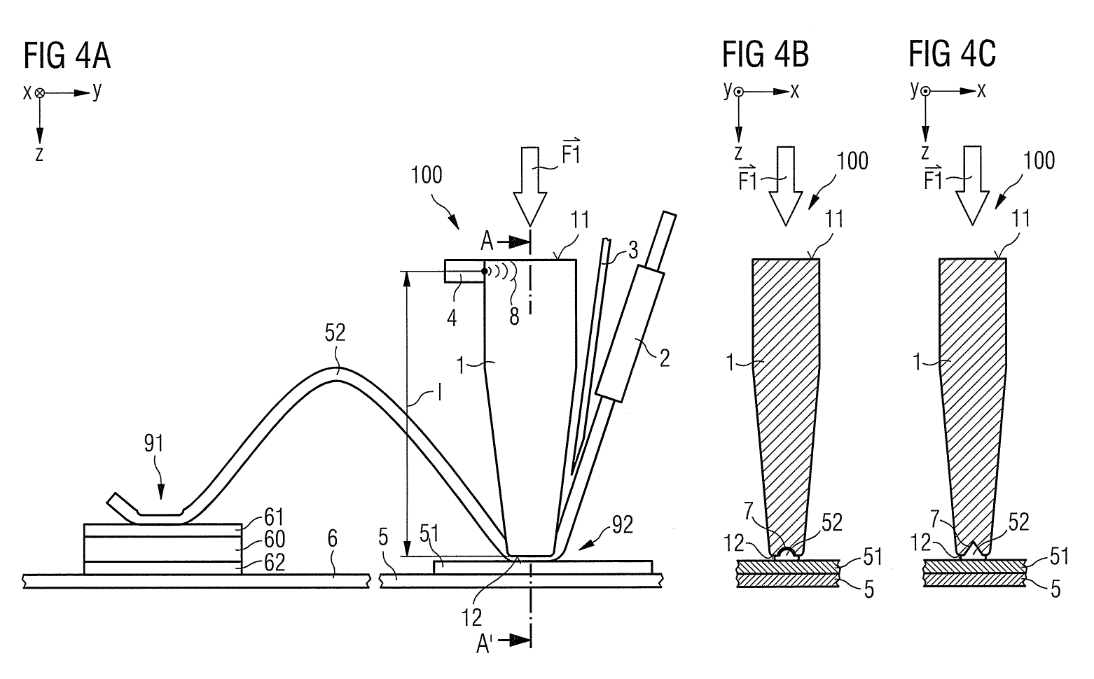

In order then to produce a fixed and permanent bonding connection between the first soldering partner embodied as metallization 51 and the second soldering partner 52 embodied as copper-based bonding wire, the bonding wire 52, as is illustrated in FIG. 4A, is pressed against the metallization 51 with a predetermined press-on force F1 by the bonding stamp 1. The predetermined press-on force F1 may be chosen such that it suffices to plastically deform the bonding wire 52 used. By way of example, a value of greater than 0.5·B_{L} or of greater than 1.0·B_{L} and/or of less than 1.5·B_{L} may be chosen for the predetermined press-on force F1, where B_{L} is the breaking load of the bonding wire 52. The breaking load of a specific wire material is usually specified by the manufacturer.

During the action of the press-on force F1, an ultrasonic wave 8 is generated by using the ultrasonic generator 4 and coupled into the bonding stamp 1 in the region of the upper end 11. In this case, the frequency of the ultrasonic wave 8 is chosen in such a way that it meets the condition:

$$0.9 \cdot n \cdot \frac{c}{2 \cdot l} \leq f \leq 1.1 \cdot n \cdot \frac{c}{2 \cdot l}$$

where c is the speed of the ultrasonic wave 8 in the bonding stamp 1 at the predetermined frequency f, and n=1 or 2 or 3 or 4. What is of importance in the production of a fixed and permanent bonding connection is the interaction of the ultrasonic wave 8 and the oscillation—caused thereby—of the lower end 12 of the bonding stamp 1 in the first lateral direction y and the press-on force F1. In this case, the ultrasonic wave 8 may be coupled into the bonding stamp 1 before, together with, or after the commencement of the press-on force F1. Independently of this, the press-on force F1 may be removed or reduced before, at the same time as, or after the end of coupling the ultrasonic wave 8 into the bonding stamp 1.

The action of the press-on force F1 results in a deformation of the bonding wire 52 in the region of the second bonding location 92 to be produced, which is illustrated in FIG. 4B in a cross-sectional view in the sectional plane A-A′ for a bonding stamp 1 having a cross-sectionally u-shaped guide groove 7, and in FIG. 4C correspondingly for a bonding stamp 1 having a cross-sectionally v-shaped guide groove 7.

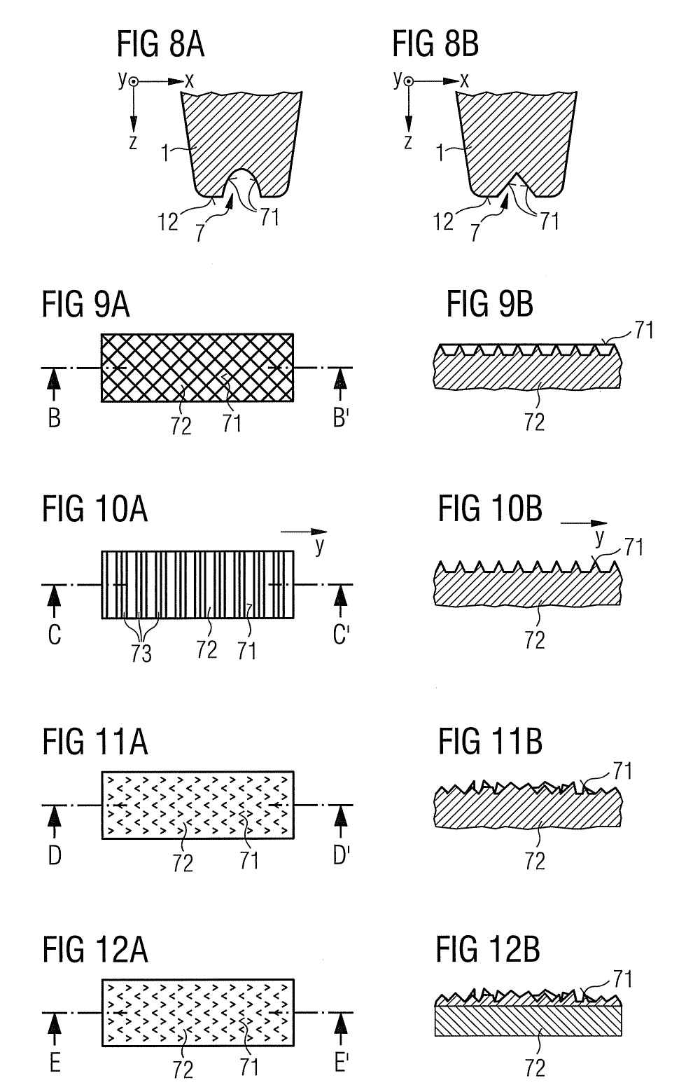

In order to achieve a good coupling between the bonding stamp 1 and the bonding wire 52 during the production of the bonding connection, the surface of such a guide groove 7 may be provided wholly or in portions with an engaging structure, for example a waffle-type structure. Examples of such engaging structures are explained in more detail below with reference to FIGS. 8A to 12B.

For a fixed and permanent bonding connection it is advantageous if the pressing of the bonding partners 51, 52 onto one another by the press-on force F1 and the excitation of the bonding stamp 1 by the ultrasonic wave 8 are effected jointly. The joint action of the press-on force F1 and of the ultrasonic wave 8 may be initiated by the ultrasonic wave 8 being coupled into the bonding stamp with the press-on force F1 already having an effect. As an alternative to this, the joint action of the press-on force F1 and of the ultrasonic wave 8 may also be initiated by the ultrasonic wave 8 being coupled into the bonding stamp before or at the same time as the introduction of the press-on force F1.

The quality of the bonding connection to be produced depends on the active power and thus on the temporal duration of the joint action of the press-on force F1 and of the bonding stamp 1 excited by the ultrasonic signal 8 on the bonding wire 52, and also on the quality of the coupling of the bonding stamp 1 to the bonding wire 52. In addition, the ratio of bonding force and ultrasonic power is crucial; otherwise, either the lower end of the bonding stamp 1 may slip over the surface of the bonding wire 52 without carrying along the bonding wire 52, or the oscillation of the bonding stamp 1 may be damped to a standstill with an excessively high press-on force F1. In the event of an excessively short joint action of the press-on force F1 of the bonding stamp 1 excited by the ultrasonic signal 8 and/or in the event of an excessively small press-on force F1 and/or in the event of an excessively small amplitude of the lower end 12 of the bonding stamp 1, this results in a bonding connection having an excessively low bonding intensity between the bonding partners 51 and 52. Conversely in the event of an excessively long joint action of the press-on force F1 of the bonding stamp 1 excited by the ultrasonic signal 8 and/or in the event of an excessively high press-on force F1 and/or in the event of an excessively high amplitude of the lower end 12 of the bonding stamp 1, this correspondingly results in a material weakening of the bonding wire 52, such that there is the risk of the bonding wire 52 tearing away at the bonding location 92, or of the occurrence of great damage to the bonding wire 52 in the heel region or even to impressions of the bonding stamp 1 on the surface of the bonding partner, here the metallization 51.

In order to obtain a high-quality bonding connection, the interaction of the predetermined press-on force F1 and of the coupled-in ultrasonic wave 8 may be made dependent on the ultrasonic energy that is transmitted from the ultrasonic generator 4 via the bonding stamp 1 onto the bonding location 92 reaching or exceeding a predetermined value. By way of example, the electrical energy fed into the ultrasonic generator 4 for the operation of the ultrasonic generator 4 may be used as a measure of the ultrasonic energy fed to the second bonding location 92. In this case it is necessary, of course, to take account of losses resulting from the efficiency of the ultrasonic generator 4 and the coupling thereof to the bonding stamp 1, for example by using an efficiency factor.

In addition, the press-on force F1 and/or the difference energy (“active energy”) between the energy fed to the second bonding location 92 and the energy (“reactive energy”) reflected from the second bonding location 92 may be used to determine the ultrasonic energy fed to the second bonding location 92. The difference between the energy fed to the second bonding location 92 and the energy reflected from the second bonding location 92 is in this case a measure of the ultrasonic energy introduced into the second bonding location 92. In order to be able to feed a sufficient amount of energy to the bonding location 92 for producing a bonding connection with a copper-based bonding wire 52 having a copper proportion of, for example, at least 99% by weight, the ultrasonic generator 4 may be designed to provide an ultrasonic power P_{US} for which the following holds true:

$${P}_{US} > \frac{\sqrt{{A}_{52}}}{7} \frac{W}{µm}$$

where A₅₂ is the cross-sectional area of the bonding wire. Likewise, the ultrasonic power P_{US} that can be provided by the ultrasonic generator may be at least 250 W.

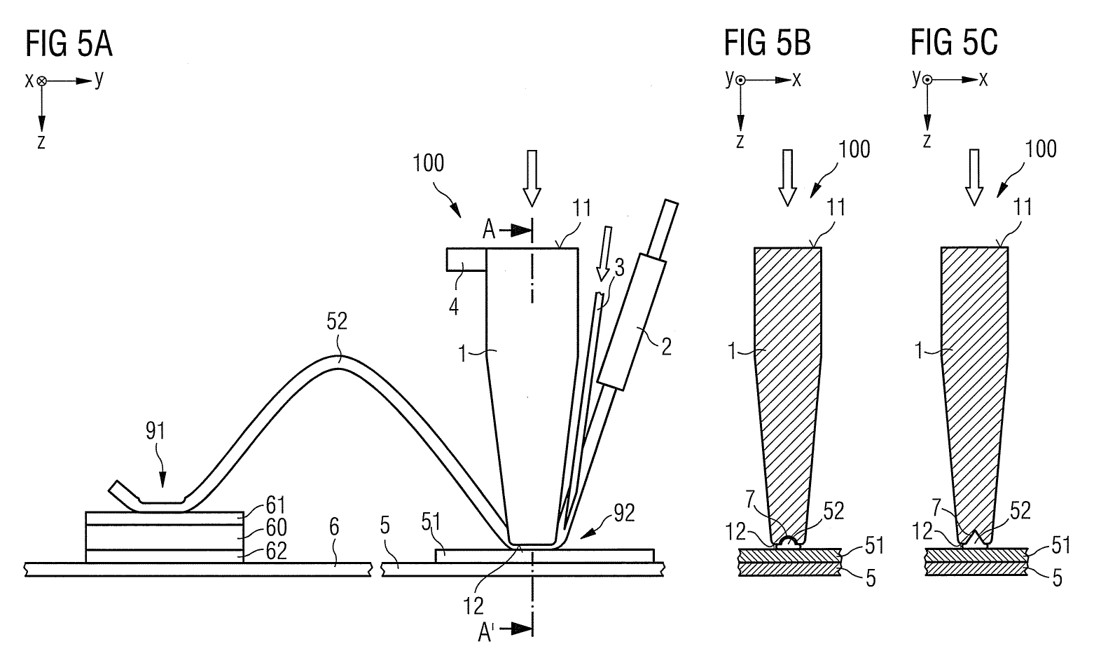

After the production of the bonding connection at the second bonding location 92, the bonding wire 52 may also be bonded to one or more further bonding partners in the manner described. As an alternative to a further bonding, the bonding wire 52 may be separated using a cutting device 3. For this purpose, the cutting device 3 is moved in the direction of the metallization 51 until it wholly or partly severs the bonding wire 52, which is illustrated in FIG. 5A. FIGS. 5B and 5C illustrates vertical sections through the sectional plane A-A′ that may be seen from FIG. 5A for a bonding stamp 1 having a cross-sectionally u-shaped and, respectively, v-shaped guide groove 7. In the case of only partial severing, the bonding wire 52 is finally torn away as a result of the bonding device 100, together with that portion of the bonding wire 52 which is moved by the guide device 2, moving away from the second bonding location 92.

Instead of complete or partial severing of the bonding wire 52, the bonding wire 52 may also be torn away by fixedly securing the bonding wire 52 to the bonding device 100, for example in the region of the guide device 2, and moving the bonding device 100 away from the metallization 51. If exclusively a tearing away of the bonding wire 52 is provided, it is possible to dispense with equipping the bonding device 100 with a cutting device 3.

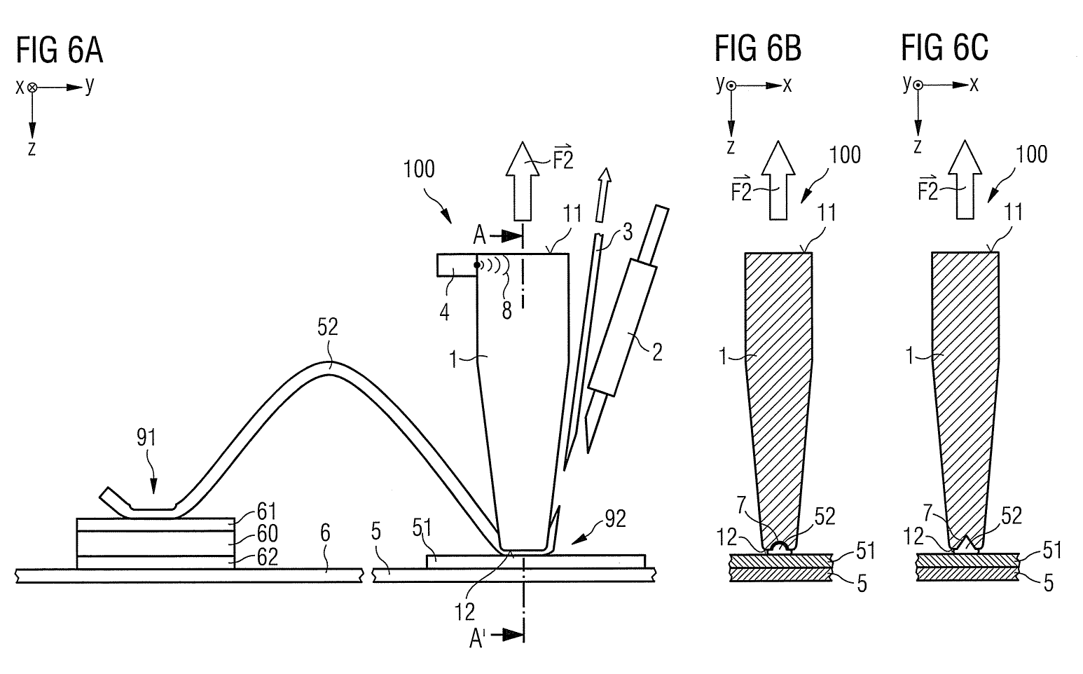

Particularly if the side wall of the guide groove 7 includes an engaging structure, it can happen that the bonding stamp 1 does not readily disengage when the bonding device 100 moves away from the metallization 51 and from the bonding wire 52. In order to facilitate a detachment, the bonding device 100 may optionally be moved away from the metallization 51 with a predetermined force F2 counter to the vertical direction z and with ultrasonic waves 8 simultaneously being coupled into the bonding stamp 1, which is illustrated in FIG. 6A. FIGS. 6B and 6C in turn illustrates cross sections in the sectional plane A-A′ for bonding stamps 1 having cross-sectionally u-shaped and, respectively, v-shaped guide grooves 7.

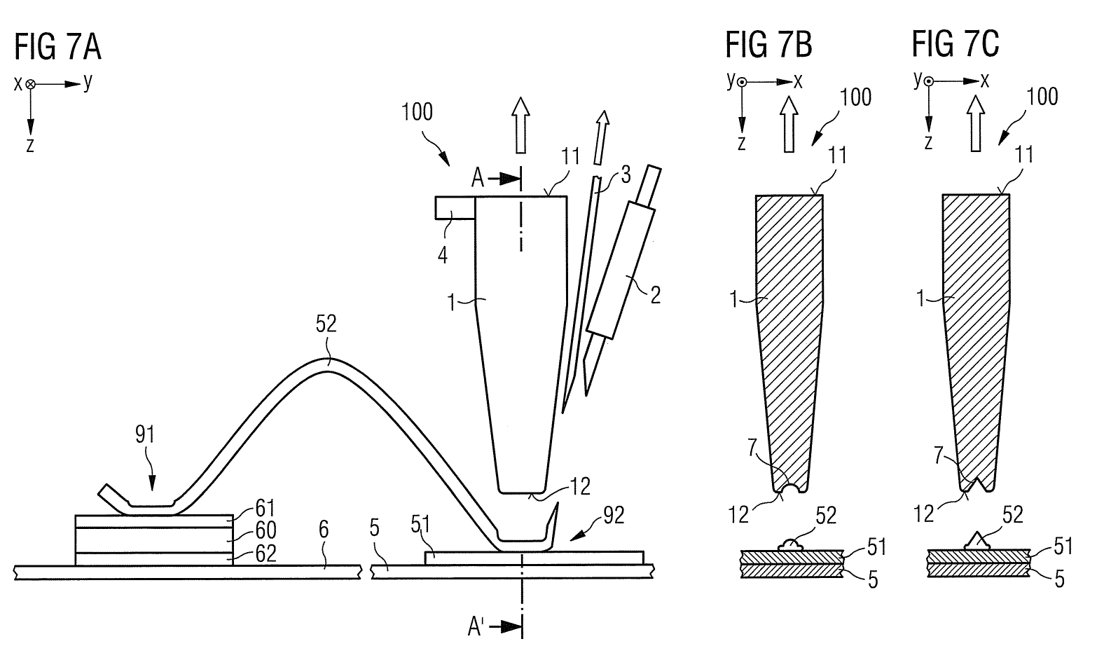

After the detachment of the bonding stamp 1 from the bonding wire 52, the second bonding location 92 has been completed, which is illustrated as the result in FIG. 7A in side view and also in sectional views in the sectional plane A-A′ for a bonding stamp 1 having a cross-sectionally u-shaped and v-shaped guide groove 7 in FIGS. 7B and 7C, respectively.

The method explained above was explained on the basis of the production of a bonding connection between a metallization of a semiconductor chip 60, such as are provided e.g., in the case of load and control connections for IGBTs, MOSFETs, thyristors, diodes, and a metallization 51 of a substrate 5. In principle, it is possible to produce the bonding connections between any metallic structures. By way of example, suitable metallic structures include chip carriers, or connecting lugs of a power semiconductor module, which are soldered or welded onto a circuit carrier or are plugged into the housing frame of a power semiconductor module.

The method explained may be used in one embodiment for making an integrated circuit including producing wedge-wedge bonding connections.

FIG. 8A illustrates an enlarged view of the bonding stamp 1 known from FIGS. 2B, 3B, 4B, 5B, 6B and 7B with a cross-sectionally u-shaped guide groove 7 in the region of a horizontal portion 72 of the guide groove 7. A corresponding view for a bonding stamp 1 with a cross-sectionally v-shaped guide groove 7 is illustrated in FIG. 8B. The guide grooves 7 in accordance with FIGS. 8A, 8B may optionally be provided with engaging surface structures at least in portions. Such an engaging structure may be formed for example as a waffle-type structure, as is illustrated in FIG. 9A in a plan view of the lateral area 71, and in FIG. 9B from a cross-sectional view in a sectional plane B-B′ which can be seen from FIG. 9A and runs perpendicular to the surface 71.

In accordance with a further alternative, a surface 71 of a guide groove 7 may include transverse grooves 73 running perpendicular to the guide groove 7 and thus perpendicular to the first lateral direction y, which is illustrated in FIG. 10A in plan view and is also illustrated in FIG. 10B in a cross-sectional view through the sectional plane C-C′ which can be seen from FIG. 10A and which runs perpendicular to the surface 71.

An engaging structure of a surface 71 of the guide groove 7 may include for example a predetermined surface roughness R_{q} of 2% to 30% of the thickness d of the bonding wire 52, i.e. the thickness thereof in the vertical direction z. In the case of a bonding wire 52 having a circular cross section, d is identical to the diameter D of the bonding wire. If a bonding wire 52 embodied as a flattened ribbon is used instead of a bonding wire 52 having a circular cross section, then d is the smallest thickness of the ribbon as viewed in the cross section of the ribbon. As an example, FIG. 11A illustrates in a plan view of the surface 71 of the guide groove 7 and FIG. 11B illustrates in a cross-sectional view through the sectional plane D-D′ which can be seen from FIG. 11A and which runs perpendicular to the surface 71 an engaging structure having a specific surface roughness.

As is illustrated in FIGS. 12A and 12B, moreover, an engaging structure may also subsequently be produced by applying a suitable material, for example diamond, to the surface 71 of the guide groove 7, which is illustrated from FIG. 12A in a plan view of the surface 71 of the guide groove 7 and in FIG. 12B in a cross-sectional view in a sectional plane E-E′ which is perpendicular to the surface 71 and which can be seen from FIG. 12A. The associated surface roughness R_{q} may be chosen for example likewise, as already described above, to be from 2% to 30% of the thickness d of the bonding wire 52.

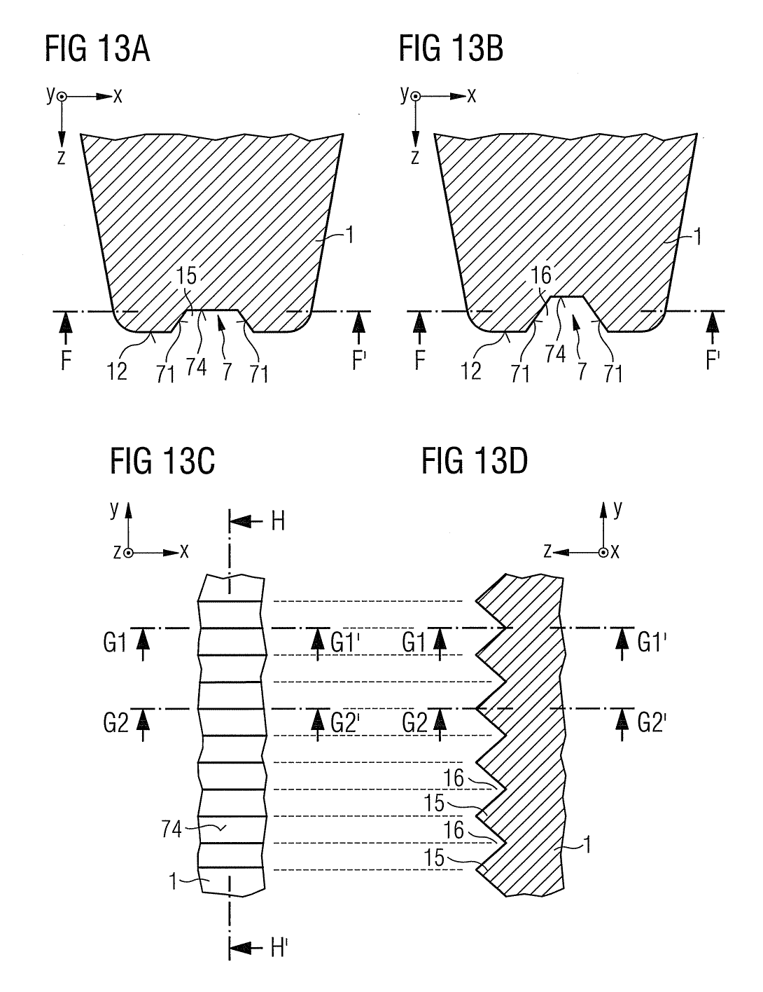

A further example of the configuration of a guide groove 7 of a bonding stamp 1 is illustrated in FIGS. 13A to 13D. FIG. 13A illustrates a vertical section through the lower portion of a bonding stamp 1 having a guide groove 7. The guide groove 7 includes a transverse groove structure with transverse grooves running perpendicular to the vertical direction z and perpendicular to the guide groove 7. The transverse groove structure includes a number of elevations 15 between which recesses 16 are respectively formed, which represent the transverse grooves. One such recess 16 is illustrated in FIG. 13B in a sectional view parallel to the view in accordance with FIG. 13A.

FIG. 13C illustrates a plan view of the guide groove 7 from below, that is to say counter to the vertical direction z, and FIG. 13D illustrates a cross section through the lower portion of the bonding stamp in a sectional plane H-H′ which can be seen from FIG. 13C. It is evident from the joint consideration of FIGS. 13A to 13D that the transverse grooves run at the top side 74 of the guide groove in the lateral direction x and thus perpendicular to the guide groove 7 running parallel to the y-z plane.

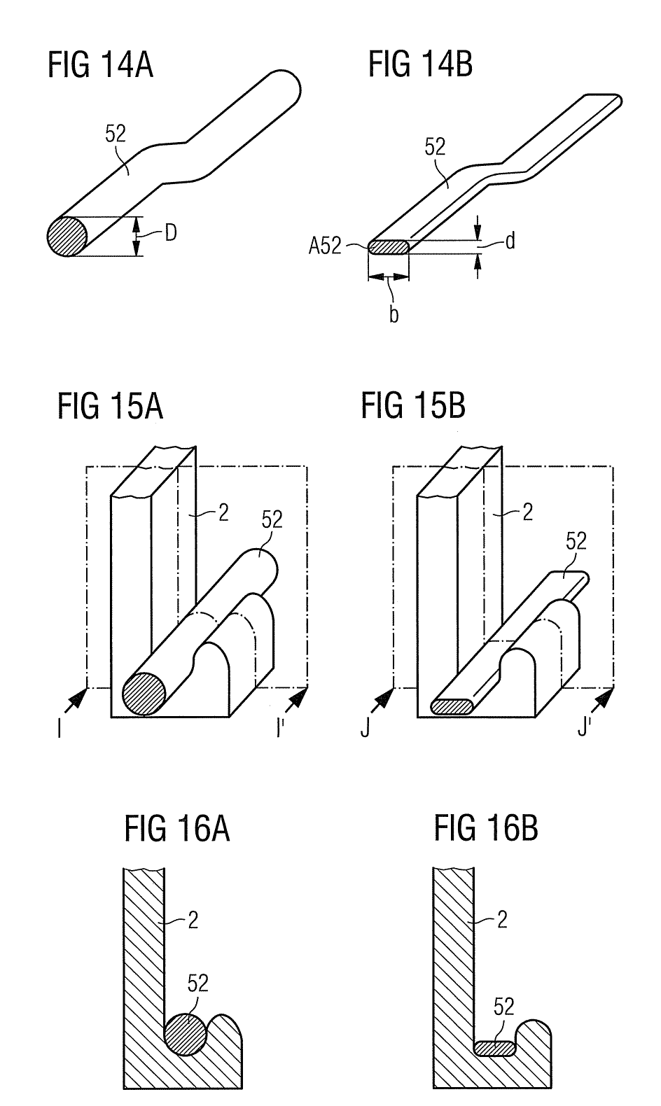

The production of a bonding connection between a bonding wire having a circular cross section and a metallization of a substrate has been described on the basis of the exemplary embodiments in accordance with FIGS. 2B to 7C. Bonding wires formed as flat ribbons may also be used instead of bonding wires having circular cross sections. FIG. 14A illustrates a portion of a bonding wire 52 having a circular cross section in perspective view. The diameter D of the bonding wire 52 may be for example 150 μm to 400 μm, 400 μm to 600 μm, or 600 μm to 1500 μm. Likewise, the bonding wire 52 may have a diameter of greater than or equal to 400 μm. The cross-sectional area A52 of the bonding wire 52 is then greater than 0.125 mm².

FIG. 14B correspondingly illustrates a ribbon 52 having a width b, a thickness d and a cross-sectional area A52. The width b may be for example between 300 μm and 15 000 μm, and the thickness d may be for example between 50 μm and 500 μm. The cross-sectional area A52 may be for example greater than 0.125 mm². Moreover, the cross-sectional area A52 may be e.g., 0.018 mm² to 0.125 mm² or 0.125 mm² to 0.283 mm² or 0.283 mm² to 1.77 mm².

With the bonding device 100 illustrated in FIG. 1A and with the method explained with reference to FIGS. 2A to 7C, it is possible to employ both conventional bonding wires or ribbons, for example those composed of aluminum or based on aluminum, e.g., composed of aluminum with an, e.g., 1%, silicon proportion, with admixtures of magnesium or titanium, composed of gold or based on gold, in the same way as bonding wires composed of copper or based on copper. By way of example, bonding wires or ribbons composed of oxygen-and carbon-free copper (Cu-Of) are suitable as copper-based bonding wires or ribbons. Copper-based bonding wires or ribbons may be copper alloys.

By way of example, material having a copper proportion of at least 99.99% by weight is suitable as oxygen- and carbon-free copper. A suitable bonding wire has for example a composition according to the standard DIN CEN/TS 13388, which is permitted to include a copper proportion of at least 99.99% by mass with admixtures of in each case at most 0.0025% by mass of silver (Ag), 0.0015% by mass of sulfur (S), 0.0010% by mass of nickel (Ni), 0.0010% by mass of iron (Fe) and 0.0003% by mass of phosphorus (P), wherein the copper (Cu) is to be produced from Cu-CATH-1 (CR001A) in accordance with the standard DIN EN 1978. Further admixtures are in each case at most 0.0005% by mass of arsenic (As), 0.00020% by mass of bismuth (Bi), 0.0001% by mass of cadmium (Cd), 0.0005% by mass of manganese (Mn), 0.0005% by mass of lead (Pb), 0.0004% by mass of antimony (Sb), 0.00020% by mass of selenium (Se), 0.0002% by mass of tin (Sn), 0.00020% by mass of tellurium (Te) and 0.0001% by mass of zinc (Zn). Moreover, the oxygen content should in this case be set in such a way that the requirements in accordance with the standard DIN EN 1976 are met.

In the case where copper-based bonding wires or ribbons are used, the guide device 2 illustrated in FIG. 1A may be produced from plastic. As an alternative to this, instead of plastic, it is also possible to use ceramic or metal, e.g., brass, since these materials have a higher resistance to the abrasion by copper-based bonding wires than plastic, or since the mechanical properties and thus also the wear are adapted better to copper because the wire guide bends the bonding wire 52 during movements of the bonding stamp 1 in the direction of the bonding stamp 1. FIGS. 15A and 15B illustrates portions of such guide devices 2 composed of metal or ceramic for a bonding wire 52 having a circular cross section and, respectively, for a ribbon 52, in each case in perspective view. FIG. 16A illustrates a cross section through the arrangement in accordance with FIG. 15A in a sectional plane I-I′, and FIG. 16B illustrates a cross section through the arrangement in accordance with FIG. 15B in a sectional plane J-J′.

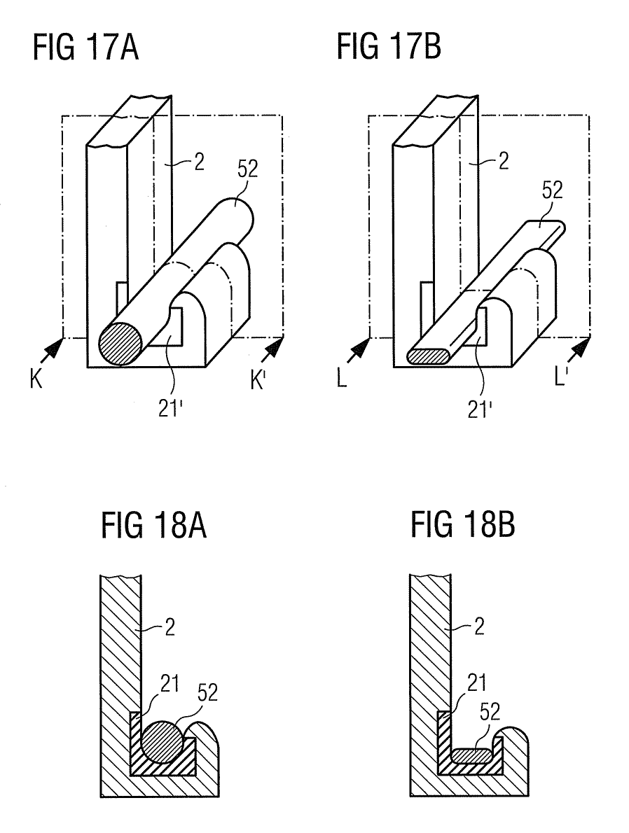

As an alternative to the exemplary embodiments in accordance with FIGS. 15A and 15B, and 16A and 16B, the guide devices 2 may also include just on their side facing the bonding wire 52 to be guided, or facing the ribbon 52 to be guided, a portion, a coating or an insert composed of ceramic or composed of metal, for example composed of one of the abovementioned ceramics or metals, which is illustrated by way of example in FIG. 17A for a bonding wire 52 having a circular cross section and in FIG. 17B for a ribbon 52. FIG. 18A illustrates a cross section through the arrangement in accordance with FIG. 17A in a sectional plane K-K′, and FIG. 18B illustrates a cross section through the arrangement in accordance with FIG. 17B in a sectional plane L-L′.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A device comprising:
a bonding stamp comprising an upper end and a lower end, which are spaced apart from one another in a vertical direction; and
an ultrasonic generator, configured to generate ultrasound of at least one predetermined frequency f and is configured to be coupled acoustically to the bonding stamp at a coupling location of the bonding stamp in the region of the upper end; wherein frequency f and an effective length l, which is given by the distance between the coupling location and the lower end in the vertical direction, are coordinated with one another in such a way that the following holds true:
$$0.9 \cdot n \cdot \frac{c}{2 \cdot l} \leq f \leq 1.1 \cdot n \cdot \frac{c}{2 \cdot l}$$
where c is the speed of the ultrasound in the bonding stamp at the frequency f, and n=1 or 2 or 3 or 4.

2. The device of claim 1, wherein the bonding stamp comprises at its lower end a guide groove for an elongate conductor to be bonded, wherein at least one horizontal portion of the guide groove runs in a first lateral direction perpendicular to the vertical direction.

3. The device of claim 2, wherein the guide groove comprises a u-shaped or a v-shaped cross section in its horizontal portion in a sectional plane perpendicular to the first lateral direction.

4. The device of claim 2, wherein the guide groove comprises a side wall with an engaging structure.

5. The device of claim 4, wherein the side wall comprises in the region of the engaging structure an RMS surface roughness of 2% to 30% of the width and/or of 2% to 30% of the depth of the guide structure of the bonding tool.

6. The device of claim 4, comprising wherein the engaging structure is formed as a waffle-type structure or as a structure running transversely with respect to the first lateral direction.

7. The device of claim 4, wherein the engaging structure comprises diamonds or ceramic fragments.

8. The device of claim 1, comprising wherein the bonding stamp has a sound speed that is higher than 10 000 m/s.

9. The device of claim 8, wherein the bonding stamp comprises silicon carbide or is formed from silicon carbide.

10. The device of claim 1 with a guide device for guiding a bonding wire, wherein the guide device comprises a surface portion composed of metal and/or composed of ceramic at least at its side facing a bonding wire to be guided.

11. The device of claim 1, comprising wherein the bonding stamp is designed to generate a bonding force of 40 N in the vertical direction.

12. The device of claim 1, comprising wherein the ultrasonic generator is designed to provide ultrasonic signals having different frequencies.

13. The device of claim 1, comprising wherein the ultrasonic generator is designed to alter the frequency of the ultrasonic signal during the bonding operation at the same bonding location and/or to provide ultrasonic signals having different frequencies within the same bonding sequence for the bonding of bonding locations that are to be successively bonded.

14. The device of claim 1, comprising wherein the ultrasonic generator is designed to provide an ultrasonic signal having an ultrasonic power of at least 250 W.

15. A method for producing a bonding connection between a first bonding partner and a second bonding partner, comprising:
providing a first bonding partner and a second bonding partner;
arranging the second bonding partner between the first bonding partner and the bonding stamp; and
generating ultrasound of the frequency f by using an ultrasonic generator and coupling the ultrasound into the bonding stamp in the region of the upper end whilst simultaneously pressing the second bonding partner onto the first bonding partner by using the bonding stamp, including defining the frequency f and an effective length l, which is given by the distance between the coupling location and the lower end in the vertical direction, are coordinated with one another in such a way that the following holds true:
$$0.9 \cdot n \cdot \frac{c}{2 \cdot l} \leq f \leq 1.1 \cdot n \cdot \frac{c}{2 \cdot l}$$
where c is the speed of the ultrasound in the bonding stamp at the frequency f, and n=1 or 2 or 3.

16. The method of claim 15, wherein the second bonding partner consists of copper or comprises a proportion of at least 99% by weight of copper.

17. The method of claim 16, comprising wherein the second bonding partner is free of oxygen and/or carbon.

18. The method of claim 15, comprising forming the second bonding partner as a wire having a diameter of 150 μm to 400 μm.

19. The method of claim 15, in which the second bonding partner is formed as a wire having a diameter of 400 μm to 600 μm.

20. The method of claim 15, comprising forming the second bonding partner as a wire having a diameter of 600 μm to 1500 μm.

21. The method of claim 15, comprising ending the process of simultaneously coupling in the ultrasound and pressing the second bonding partner onto the first bonding partner depending on the ultrasonic energy emitted by the bonding stamp.

22. The method of claim 21, comprising ending the process of simultaneously coupling in the ultrasound and pressing the second bonding partner onto the first bonding partner depending on the difference energy (active energy) between the ultrasonic energy emitted by the bonding stamp and the ultrasonic energy (reactive energy) reflected from the bonding location.

23. The method of claim 15, comprising wherein the first bonding partner and the second bonding partner have resonant frequencies, and separating the frequency or the frequencies of the ultrasound used for producing the bonding connection from the resonant frequencies by at least 5 kHz.

24. A method for making an integrated device including producing a bonding connection between a first bonding partner and a second bonding partner, comprising:
providing a bonding device comprising a bonding stamp, an ultrasonic generator, which is designed to generate ultrasound of at least one predetermined frequency f, providing a first bonding partner and a second bonding partner, arranging the second bonding partner between the first bonding partner and the bonding stamp, generating ultrasound of the frequency f by using the ultrasonic generator and coupling the ultrasound into the bonding stamp whilst simultaneously pressing the second bonding partner onto the first bonding partner by using the bonding stamp; and
ending the process of simultaneously coupling in the ultrasound and pressing the second bonding partner onto the first bonding partner depending on the ultrasonic energy emitted by the bonding stamp.

25. The method of claim 24, comprising wherein ending the process of simultaneously coupling in the ultrasound and pressing the second bonding partner onto the first bonding partner is additionally effected depending on the ultrasonic energy reflected from the first bonding partner and from the second bonding partner.
